(19) United States
(12) Patent Application Publication
(10) Pub. No.: US 2001/0046529 A1
(43) Pub. Date: Nov. 29, 2001

(54) Apparatus for distributing furnish material in the compression molding of cellulosic articles

(76) Inventors: Anthony Joseph Cline, Muscatine, IA (US); Christopher Patrick Schrauth, Muscatine, IA (US); Stacy Bazal, Muscatine, IA (US); Dallas Scott Calvelage, Muscatine, IA (US)

Correspondence Address: Ronald A. Sandler, Jones, Day, Reavis & Pogue, 77 West Wacker Drive, Chicago, IL, 60601-1692, US

(21) Appl. No.: 09/802,276

(22) Filed: Mar. 8, 2001

Related U.S. Application Data
(60) Provisional application No. 60/188,468, filed on Mar. 10, 2000.

(51) Int. Cl. B29C 31/02

(52) U.S. Cl. 425/447

(57) ABSTRACT

A distribution system for distributing wood furnish in a multiple-mold compression molding apparatus includes an upper mobile hopper which is selectively translatable along a rail to be positioned over one of multiple lower distributing hoppers such that the distributing hoppers can selectively load respective molds. Preferably, the mobile hopper is provided with a clam shell discharge gate.

### CROSS REFERENCE TO RELATED APPLICATION

Priority is claimed from U.S. Provisional application Serial No. 60/188,468, filed Mar. 10, 2000.

### BACKGROUND OF THE INVENTION

1. Field of the Invention

The present invention relates generally to compression molding of cellulosic articles and, more particularly, to apparatus for effectively distributing furnish material in the molding under heat and pressure of thermosetting resin coated wood fiber furnish which has been recycled from waste wood articles.

2. Description of the Related Art

It has long been known that synthetic products can be manufactured using a thermosetting binder, heat and pressure to reconsolidate refined cellulosic and/or lignocellulosic furnish materials into unitary rigid products. One common form of such products is particle board or fiberboard. The binders usually used in producing particle board, for example, are thermosetting resins such as urea-formaldehyde or phenol-formaldehyde. An example of a process for manufacturing such boards is disclosed in early U.S. Pat. No. 2,757,115 issued to Heritage. Basically, this patent teaches reducing a furnish material, such as wood, to fibers by a refiner, mixing the fibers with a binder and other chemicals such as release and sizing agents, forming the mixture into mats and compressing the mats between heated platens in a hot press to form board products of a desired thickness and density. Waste disposal is an ever increasing concern to society. Although recycling efforts have been relatively successful with a variety of materials, certain materials have continually posed a problem as being generally non-recyclable. Examples of these hard-to-recycle materials include urban wood waste such as demolition waste from old buildings, wood chips generated from construction materials, old pallets and crates and the like.

In conveying and distributing ground fibers coated with a binder for processing in a molding press it has been found that difficulties can be encountered because of the tacky nature of composite material. For example, one system has been proposed whereby a rectangular tube is swung from a fixed point and the lower end of the tube is rotated to transfer material selectively to several bins. However, because of the tacky nature of the mixed material a tube slope of at least sixty degrees was required to permit the material to flow. This requires, in practice, a distribution system having a considerable and undesirable height.

Accordingly, it is desirable to provide a process for recycling urban wood waste into useful synthetic wood-base products. Further, it is desirable to provide such a process which can produce molded articles of various shapes and contours, such as, for example, chair form products for manufacturing chair seats and backs. Still further, it is desirable to provide an effective system for delivering furnish material to mold assemblies for convenience processing of the furnish material into molded articles.

### SUMMARY OF THE INVENTION

The present invention improves over the prior art by providing a distribution system for distributing wood furnish in a multiple-mold compression molding apparatus wherein an upper mobile hopper is selectively translatable along a rail to be positioned over one of multiple lower distributing hoppers such that the distributing hoppers can selectively load respective molds. Preferably, the mobile hopper is provided with a clam shell discharge gate.

### BRIEF DESCRIPTION OF THE DRAWINGS

The foregoing and other novel improvements and advantages of the invention will be better understood upon a reading of the following detailed description taken in conjunction with the accompanying drawings wherein:

FIG. 1 is a side schematic view of a system for distributing furnish in the compression molding of cellulosic articles as constructed in accordance with the principles of the invention;

FIG. 2 is a side view of a clam shell hopper of the invention and shown in the open position; and

FIG. 3 is a side view of the clam shell hopper shown as closed.

### DETAILED DESCRIPTION OF THE PREFERRED EMBODIMENTS

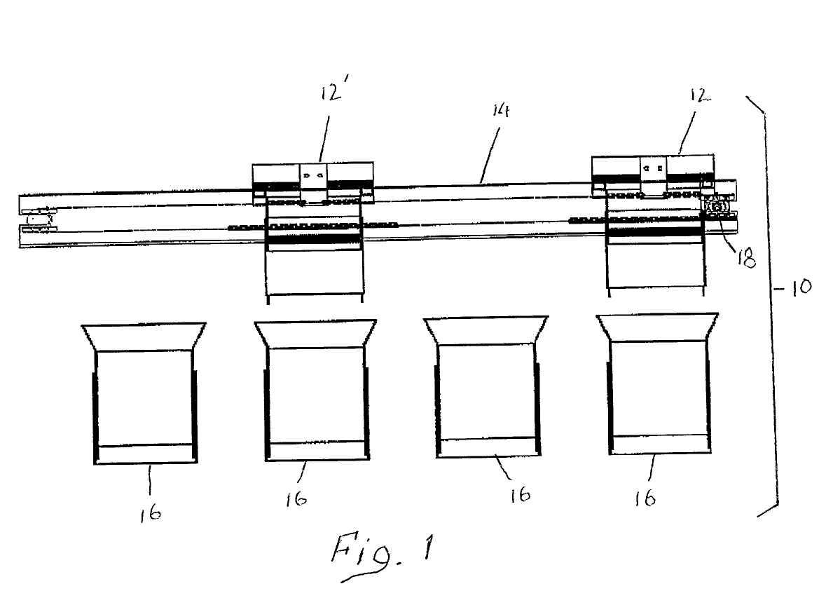

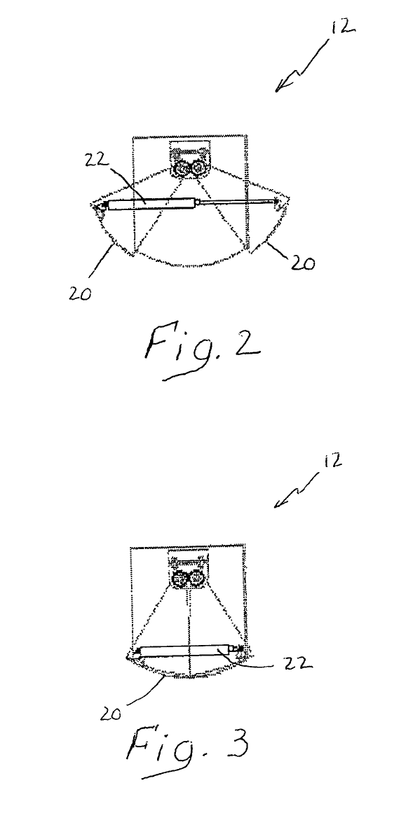

Referring now to the drawings, and initially to FIG. 1, a distribution system for distributing resin coated wood furnish in a compression molding process is designated generally by the reference numeral 10. The system 10 is particularly suitable for use in the molding of articles formed in a press under heat and pressure as disclosed in a related provisional application filed on even date herewith titled “Mold Ejection Apparatus for Use in Compression Molding of Cellulosic Articles,” the complete description of which is incorporated herein by reference in its entirety. The system 10 is also designed to be used with multiple molds. To this end, an upper mobile hopper 12 is supported for translational movement on a suitable rail 14 such that it can be selectively positioned over one of several lower receiving hoppers 16. Hopper 12 shown on the right hand side in FIG. 1 is a “home” position, while 12′, to the left, is essentially hopper 12 as moved to a left-wise position.

The hopper 12 is generally rectangular and powered by an electric motor 18 as it translates along the rail 14. As best seen in FIGS. 2 ane 3, hopper 12 is provided with a lower clam shell gate 20 which opens and closes by means of a pair of pneumatic cylinders 22, only one of which can be seen. The lower hopper 16 may have similar clam shell gates for selectively discharging the furnish into the molds.

### OPERATION

The normal sequence of operation is as follows:

1) The upper mobile hopper 12 rests at its home position under the discharge of a wood and resin mixer.

2) Wood is discharged from the mixer into the upper hopper 12.

3) The upper hopper 12 moves to the location immediately above the first lower hopper 16. An encoder that counts the number of rotations on the drive assembly determines the upper hopper's location.

4) The pneumatic cylinders 22 on the upper hopper 12 extend, dropping its batch of resin coated wood into the first lower hopper 16.

5) The cylinders 22 retract closing the upper hopper 12.

6) The upper hopper 12 returns to its home position.

7) The same sequence occurs to fill the remaining three lower hoppers 16.

8) Once the lower hoppers 16 are emptied the filing sequence repeats.

It can now be appreciated that the distribution system 10 of the present invention offers considerable advantages over the prior art and, in particular, considerably improves over the above-described rotating tube system. The system 10 allows for easy reconfiguration. The four lower hoppers 16 can be slid along their support structure and attached at varying locations. Up to two of the lower hoppers 16 can be removed if necessary. When a location change is made to one or all of the lower hoppers 16, the position also needs to be changed in the control to assure that the upper mobile hopper 12 goes to the proper location. This is a simple change to the number of revolutions the drive assembly rotates in order to get to the desired position.

While the present invention has been described in connection with preferred embodiments thereof, it will be apparent to those skilled in the art that many changes and modifications may be made without departing from the true spirit and scope of the invention. Accordingly, it is intended by the appended claims to cover all such changes and modifications as come within the spirit and scope of the invention.

What is claimed is:

1. A distribution system for distributing wood furnish in a multiple-mold compression molding apparatus comprising:
an upper hopper having an open top for receiving a quantity of wood furnish;
a rail on which said upper hopper is translatable;
a plurality of lower hoppers each positioned in registry over a mold cavity;
means to align said upper hopper selectively over one of said lower hoppers; and
means to dump the contents of said upper hopper into said one lower hopper.

2. The system of claim 1 wherein said upper hopper is translatable along said rail by an electric motor.

3. The system of claim 1 wherein said upper hopper includes a lower clam shell gate.

4. The system of claim 3 wherein said clam shell gate is operable by pneumatic cylinders.
